(19) United States
(12) Patent Application Publication
(10) Pub. No.: US 2015/0337739 A1
(43) Pub. Date: Nov. 26, 2015

(54) RAMP RATE CONTROL FOR A GAS TURBINE

(71) Applicant: Wellhead Electric Company, Inc., Sacramento, CA (US)

(72) Inventors: Christian Skov Heiberger, Fresno, CA (US); John Grant McDaniel, Sacramento, CA (US)

(21) Appl. No.: 14/717,340

(22) Filed: May 20, 2015

Related U.S. Application Data
(60) Provisional application No. 62/000,817, filed on May 20, 2014.

(51) Int. Cl. F02C 9/26; F02C 3/04

(52) U.S. Cl. CPC F02C 9/26; F02C 3/04

(57) ABSTRACT

A method for operating a gas turbine is disclosed. The method can include receiving a command for a new load set-point for a gas turbine. In response to the received new load set-point, a fuel valve of the gas turbine can be metered to a first position, the first position corresponding to a first gas turbine load less than the new load set-point. After a first predetermined time, the fuel valve can be metered to a second position, the second position corresponding to a second gas turbine load greater than the first gas turbine load and less than the new load set-point. The fuel valve is incrementally metered more open until the gas turbine is operating at the new load set-point.

### CROSS REFERENCE TO RELATED APPLICATIONS

The present application claims priority to U.S. Provisional Patent Application Ser. No. 62/000,817 filed May 20, 2014, entitled “RAMP CONTROL FOR A GAS TURBINE,” which is hereby incorporated by reference in its entirety.

### TECHNICAL FIELD

This present disclosure relates generally to energy facilities and, in particular, to methods of control for operating a gas turbine.

### BACKGROUND

Energy facilities are designed to provide energy to an electric grid in a reliable manner. Examples of energy facilities can include a gas fired generation system, such as a gas turbine generator (GTG) and a combined cycle gas turbine (CCGT). The energy facilities are configured to provide energy to the electric grid while maintaining the frequency and voltage of the electric grid within acceptable limits, such as limits set by a government body, a regulatory body, transmission grid operations, or an energy facility. Electric grid demands change depending on a number of factors including weather, market demands, and other reliability driven events. The energy facility is typically designed to ramp up, including starting, or ramp down in response to these factors.

Since the energy facilities produce power at a variety of levels based on the electric grid demands, during operation of a power producing unit, such as a gas turbine, requests are made to alter the power output, including decreasing or increasing the power output. In the instance of a new load set-point to increase the power output, the gas turbine is ramped up to the higher power output request.

### SUMMARY

The present inventors have recognized, among other things, that a problem to be solved can include reducing wear on a gas turbine during a ramping operation, such as to a new load set-point of the gas turbine. Current energy facilities and gas turbines can be configured to move to the new load set-point at pre-determined rate. Typically, the pre-determined rate of current gas turbines is a fast ramp rate, such as a maximum ramping capability of the gas turbine. Fast ramping of the gas turbine accelerates gas turbine wear caused by repeated exposure to, but not limited to, increased temperature change rates during the ramping process and initial fluctuations of pressure within the gas turbine. For example, the initial influx of fuel to start a ramp process can cause initial spikes (e.g., fluctuations or pulsations) in the pressure and temperature, which can be damaging to gas turbine components. Additionally, as gas turbine components become damaged over time, the damaged components can cause fluctuations in the pressure and temperature.

In an example, the present subject matter can provide a solution to this problem, such as by providing a method and system that can minimize or eliminate an initial damaging fluctuation of pressure when the ramping process beings and minimize thermal stress applied the gas turbine while operating at a ramp rate to achieve the new load set-point. For example, the methods and systems can include initially ramping at a minimum ramp to minimize and/or prevent any initial fluctuations/spikes in the pressure and corresponding temperature. Further, after a predetermined time of operating at the minimum ramp rate, the methods and system can include ramping to the new load set-point at a ramp rate that maintains at least the change of temperature rate below a threshold change of temperature rate. Other parameters such temperature, pressure, a change of pressure rate can also be maintained below thresholds.

The present inventors have further recognized, among other things, that a problem to be solved can include ramping a gas turbine to a new load set-point so as to meet market demands while minimizing wear on the gas turbine. The new load set-point can be a result of a number of different market demands, each of which has a unique energy product response time demand. For example, a new load set-point request in response to arrest a system transient has an immediate response time demand. A new load set-point in response to economic factors has a low priority response time demand. In an example, the present subject matter can provide a solution to this problem, such as by providing a method and system that correlates the new load set-point request and energy product response time demand, to determine two or more ramp rates of the gas turbine to minimize gas turbine wear.

Due to increased variations brought about by intermittent resources, such as wind and solar power generation, the electric market is increasingly seeking faster ramp rates for gas turbine power generation facilities in order to arrest system transients. As discussed herein, faster ramp rates, however, place a higher thermal stress (e.g., change in temperature rate) on gas turbine components and, therefore, decrease the efficiency and service life of the gas turbine. The present method and system distinguishes between the system transient new load set-point requests and other new load set-point requests to reduce the number of instances the gas turbine ramps at these higher thermal stress ramp rates, thereby increasing the service life of the gas turbine. Therefore, instead of ramping a gas turbine at the higher thermal stress ramp rates every time a new load set-point request is received, the methods and systems described herein can distinguish which of the new load set-point requests need to be ramped at the higher ramp rate; thereby reducing the overall number of high thermal stress ramps a gas turbine experiences over time and increasing the efficiency and extending the life of the gas turbines and components of the gas turbines.

Additionally, the present disclosure provides for a “soft-start” to the ramp rate of the gas turbine that can limit the initial change of the fuel valve, e.g., by the smallest movement allowed by the fuel valve, corresponding to a minimum ramp rate and then lifting (e.g., increasing) the ramp rate, for example, to a desired ramp rate or to a plurality of ramp rates until the desired ramp rate is reached and/or the new load set-point is reached. By limiting the initial and subsequent flow rate of fuel, fluctuations or pulsations initially experiences by the gas turbine are minimized and the temperature change rate during ramping can be reduced as compared to a maximum ramping rate and the service life of the gas turbine can be extended.

To better illustrate the encapsulated method and systems disclosed herein, a non-limiting list of examples is provided here:

Example 1 can include subject matter (such as a method) for operating a gas turbine comprising a receiving, at a controller, receiving, at a controller, a command for a new load set-point for a gas turbine; in response to the received new load set-point, metering a fuel valve of the gas turbine to a first position, the first position corresponding to a first gas turbine load less than the new load set-point; after a first predetermined time, metering the fuel valve to a second position, the second position corresponding to the new load set-point; and operating the gas turbine at the new load set-point.

In Example 2, the subject matter of Example 1 can optionally include where the first position corresponds to a first ramp rate and the second position corresponds to a second ramp rate, the second ramp rate greater than the first ramp rate.

In Example 3, the subject matter of Example 1 can optionally include where the first position corresponds to a minimum movement capability of the fuel valve.

In Example 4, the subject matter of Example 1 can optionally include determining the first predetermined time at least partially based on a threshold pressure change rate.

In Example 5, the subject matter of Example 1 can optionally include determining the first predetermined time at least partially based on a threshold temperature change rate.

In Example 6, the subject matter of Example 1 can optionally include determining the first predetermined time based on at least partially on an energy product associated with the command for the new load set-point.

In Example 7, the subject matter of Example 1 can optionally include, after the first predetermined time and prior to metering the fuel valve to the second position, metering the fuel valve to an intermediate position, the intermediate position corresponding to a second gas turbine load less than the new load set-point and greater than the first load set-point.

In Example 8, the subject matter of Example 1 can optionally include where the intermediate position is at least partially based on one of a threshold pressure change rate and a threshold temperature change rate.

In Example 9, the subject matter of Example 1 can optionally after the second gas turbine load is reached, metering the fuel valve to the second position.

Example 10 can include subject matter (such as a method) for ramping a gas turbine comprising receiving, at a controller, a command for a new load set-point for a gas turbine, determining a ramp rate for the gas turbine to operate at the new load set-point, incrementally metering a fuel valve of the gas turbine until the determined ramp rate is achieved, and ramping the gas turbine at the determined ramp rate until the new load set-point is reached.

In Example 11, the subject matter of Example 10 can optionally include where incrementally metering the fuel valve includes a first incremental metering at a ramp rate less than the determined ramp rate.

In Example 12, the subject matter of Example 10 can optionally include where the first incremental metering is a minimum movement capability of the fuel valve.

In Example 13, the subject matter of Example 12 can optionally include where incrementally metering the fuel valve includes doubling an aperture of the fuel valve each subsequent incremental metering to the first metering.

In Example 14, the subject matter of Example 10 can optionally include where incrementally metering the fuel valve includes incrementally increasing the ramp rate of the gas turbine.

In Example 15, the subject matter of Example 10 can optionally include where incrementally metering the fuel valve includes substantially maintaining the gas turbine at or below at least one of a threshold pressure and threshold pressure change rate.

In Example 16, the subject matter of Example 10 can optionally include where incrementally metering the fuel valve includes substantially maintaining the gas turbine at or below at least one of a threshold temperature threshold and a threshold temperature change rate.

In Example 17, the subject matter of Example 10 can optionally include determining the minimum ramp rate based at least partially on the response time demand associated with the new load set-point.

In Example 18, the subject matter of Example 10 can optionally include where incrementally metering the fuel valve is at least partially based on a type of fuel combusted in the gas turbine.

Example 19 can include subject matter (such as a system) for controlling a gas turbine comprising a gas turbine engine, a fuel valve configured to supply fuel to the gas turbine, a temperature sensor configured to sense a temperature within the gas turbine, a pressure sensor configured to sense a pressure within the gas turbine, and a controller electrically coupled to the fuel valve, the temperature sensor, and the pressure sensor. The controller is configured to receive a command including a new load set-point for the gas turbine and includes a ramp rate control unit configured to in response to receiving the new load set-point, meter the fuel valve of the gas turbine to a first position, the first position corresponding to a first gas turbine load less than the new load set-point and a first ramp rate, and metering the fuel valve to a second position, the second position corresponding to the new load set-point for the gas turbine and a second ramp rate, the second ramp rate greater than the first ramp rate.

In Example 20, the subject matter of Example 19 can optionally include prior to metering the fuel valve to the second position, metering the fuel valve to one or more intermediate positions, each intermediate position corresponding to an intermediate gas turbine load greater than the first gas turbine load and less than the second gas turbine load.

Example 21 can include, or can optionally be combined with any portion or combination or any portions of any one or more of Examples 1-20 to include, subject matter that can include means for performing any one or more of the functions of Examples 1-20, or a machine-readable medium including instructions that, when performed by a machine, cause the machine to perform any one or more of the functions of Examples 1-20.

These non-limiting examples can be combined in any permutation or combination.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a block diagram of a system, according to one example of the present disclosure.

FIG. 2 illustrates a flow diagram of a method of operating a gas turbine, according to one example of the present disclosure.

FIG. 3 illustrates a flow diagram of a method for ramping a gas turbine, according to one example of the present disclosure.

FIG. 4 illustrates a plot of a ramp profile, according to one example of the present disclosure, according to one example of the present disclosure.

FIG. 5 illustrates a plot of a ramp profile, according to one example of the present disclosure, according to one example of the present disclosure.

FIG. 6 illustrates a plot of a ramp profile, according to one example of the present disclosure, according to one example of the present disclosure.

FIG. 7 illustrates a plot of a ramp profile, according to one example of the present disclosure, according to one example of the present disclosure.

FIG. 8 illustrates a plot of a ramp profile, according to one example of the present disclosure, according to one example of the present disclosure.

FIG. 9 illustrates a plot of a ramp profile, according to one example of the present disclosure, according to one example of the present disclosure.

FIG. 10 illustrates a plot of a ramp profile, according to one example of the present disclosure, according to one example of the present disclosure.

FIG. 11 illustrates a plot of a ramp profile, according to one example of the present disclosure, according to one example of the present disclosure.

### DETAILED DESCRIPTION

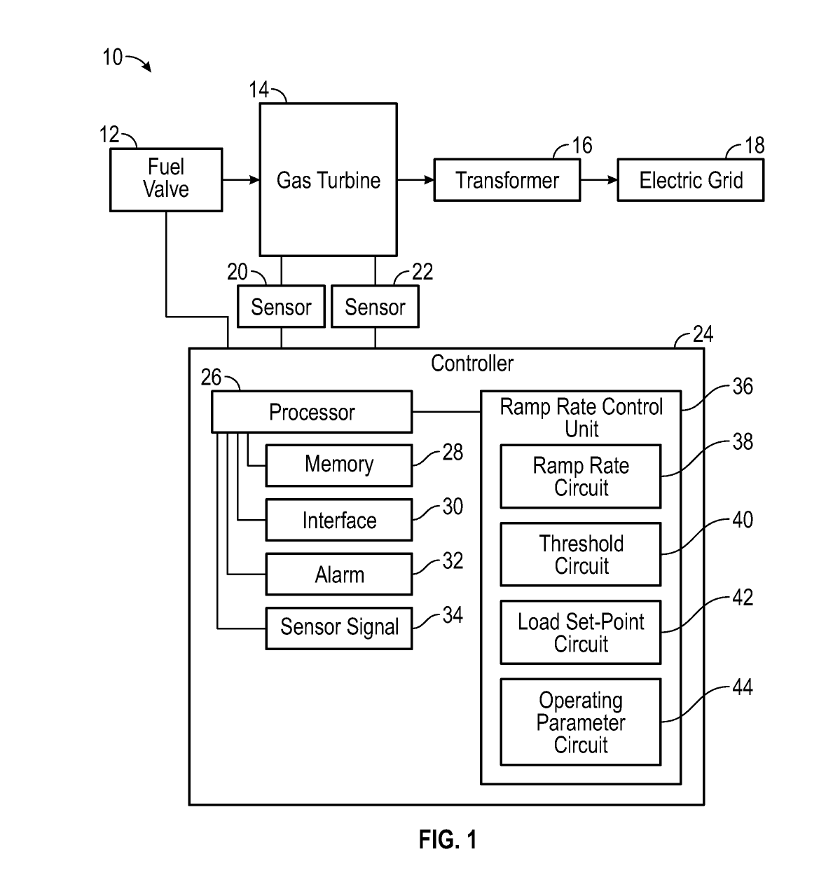

FIG. 1 illustrates an example of a block diagram of an energy system 10, according to an example of the present disclosure. The energy system 10 can include a gas turbine 14, a fuel valve 12, a transformer 16, and an electric grid 18. The energy system 10 can also include a temperature sensor 20, a pressure sensor 22, and a controller 24 for controlling the operation of the gas turbine 14.

The transformer 16 can convert the output of the gas turbine 14 to a higher voltage prior to being provided to the electric grid 20. Although the energy system 10 shown in FIG. 1 shows only one gas turbine 10, examples are not so limited. The energy system 10 can include a plurality of gas turbines 14 and a plurality of fuel valves 12, where each fuel valve corresponds to one gas turbine. In an example, the energy system 10 can be located in multiple geographic locations, such that the gas turbine 12 can be separated from controller 23, for example. Thus, the footprint of the energy system 10 is not limited to a single continuous location.

The gas turbine 14 can be configured to provide a power output, including up to a full-load power output. In an example, the gas turbine 14 can include a turbine, such as an aero-derivative or heavy duty gas turbine having the full-load power output within a range from about 10 megawatts (MW) to about 250 MW or more, in some examples. In an example, the gas turbine 14 can be configured for a fast start. For example, the gas turbine 14 can be configured for a fast start within about 20 minutes or less, for example, about 10 minutes or less, about 5 minutes or less, or about 2 minutes or less.

Starting the gas turbine 14 includes changing the gas turbine 14 from the stand-by state (e.g., off-line but substantially immediately ready to start) to a desired load of the gas turbine 14, including up to the full-load power output. Off-line can include a non-power producing state of the gas turbine 14. In an example, the stand-by state of the gas turbine 14 includes the gas turbine 14 off-line, but substantially immediately ready to start. In an example, the gas turbine 14 can include an auto-start feature configured to start the gas turbine 14 in response to a frequency disturbance event. That is, in an example, the energy system 10 can provide the gas turbine 14 droop-like capability when off-line in response to a frequency disturbance event, such as a transient or decay in frequency. In an example, the gas turbine 14 can include a clutch between the gas turbine engine and the generator, so as to provide substantially synchronous condensing. Such a configuration can allow the energy system 10 to provide a substantially continuous and a substantially immediate response to electric grid transient voltage events.

In an example, the energy system 10 can adjust the current load based on receiving a command for a new load set-point for the gas turbine 14. As discussed herein, the electric grid 18 demands can change depending on a number of factors including weather, market demands, and other reliability driven events. When a new load set-point is received, the energy system 10 can reach the new load set-point within any response time demand while reducing the wear on the gas turbine 14.

The energy system 10 can include a pressure sensor 20 and a temperature sensor 22. The pressure sensor 20 can be configured to sense the current operating pressure of the gas turbine 12. The pressure sensor 20 can be electrically coupled to the controller 24 such that the pressure sensor 20 can send a signal indicating the current operating pressure to the controller 24. The temperature sensor 22 can be configured to sense the current operating temperature of the gas turbine 12. The temperature sensor 22 can be electrically coupled to the controller 24 such that the temperature sensor 22 can send a signal indicating the current operating temperature to the controller 24.

In an example, the pressure and temperature sensors 20, 22 can continuously sense and send the current operating pressure and temperature to the controller 24. In another example, the pressure and temperature sensors 20, 22 can intermittently sense and send the current operating pressure and temperature to the controller 24. For example, when the gas turbine 14 is operating at a constant load, the pressure and temperature sensors 20, 22 can sense and send the current operating pressure and temperature to the controller 24 at intervals, for example, every few minutes. However, during ramping, the pressure and temperature sensors 20, 22 can continuously sense and send the current operating pressure and temperature to the controller 24.

As discussed herein, certain temperatures and pressures within a gas turbine 14 can be damaging to components of the gas turbine 14 and reduce the efficiency and lifetime of the gas turbine 14. For example, having repeated fluctuations of pressure when initiating a ramp and/or having the temperature change rate during a ramp repeatedly exceed a threshold temperature change rate, can damage components within the gas turbine 14 and decrease the efficiency and life of the gas turbine 14, as well as increase the operating costs of the gas turbine 14. When the gas turbine 14 is ramped, the temperature, pressure, temperature change rage, and pressure change rate can vary within the gas turbine 14. For example, when the initial flow rate of the fuel is changed, the pressure can spike or fluctuate. Further, depending on the ramp rate of the gas turbine, the temperature change rate. That is, the higher the ramp rate the higher the temperature change rate.

As discussed herein, the energy system 10 of the present disclosure can minimize any initial pressure fluctuation or spikes when the ramping process beings to within a threshold pressure change. However, threshold pressure change can vary between different gas turbine systems. As described herein, the “threshold pressure change” is a fluctuation of pressure that occurs in a gas turbine as the ramping process begins (simultaneously with the change in fuel rate) or during ramping. Further, the energy system 10 of the present disclosure can maintain the change of temperature rate during ramping to a new load set-point to below a threshold temperature change rate. The threshold temperature change rate can vary between different gas turbines, as each gas turbine 14 can handle different temperature change rates.

In an example, the threshold temperature change rate and the threshold pressure change can be dependent on the particular gas turbine 14 and how long the gas turbine 14 has been operating. For example, a newer gas turbine may be able to have a higher threshold pressure or threshold temperature as compared to an older gas turbine. In an example, the threshold pressure change can be, but is not limited to, less than 15 pounds per square inch (psi). In an example, the threshold pressure change can be, but is not limited to, less than 10 psi such as 9 psi, 8 psi, 7 psi, 6 psi, 5 psi, 4 psi, 3 psi, 2 psi, 1 psi and zero psi.

As discussed herein, certain temperature change rates (° C./time) and corresponding pressure change rates (psi/time), can be damaging to components of the gas turbine 14 and reduce the efficiency and lifetime of the gas turbine 14. For example, having temperature change rates within the gas turbine 14 during ramping that repeatedly exceed a threshold temperature change rate, can damage components within the gas turbine 14 and decrease the efficiency and life of the gas turbine 14 as well as increase the operating costs of the gas turbine 14. When the gas turbine 14 is ramped, the temperature change rate can vary depending on the ramp rate. In an example, as the ramping rate of the gas turbine 14 increases, so does the temperature change rate and corresponding pressure change rate.

The threshold temperature change rate can be a predetermined difference from a maximum temperature change rate that the gas turbine is configured to run without stalling, including any design limitations. The threshold temperature change rate can be dependent on the particular gas turbine 14 and how long the gas turbine 14 has been operating. For example, a newer gas turbine may be able to handle a higher threshold temperature change rate as compared to an older gas turbine. The energy system 10 of the present disclosure can be configured to ramp the gas turbine 14 at ramp rates below the threshold temperature change rate.

As discussed further herein, there may be instances where the gas turbine 14 needs to be ramped at a ramp rate that will increase the temperature change rate or include pressure fluctuations that extend beyond the threshold temperature change rate and the threshold pressure.

For example, certain commands for a new load set-point can have an associated response time demand. In some instances, the response time demand may not be met without ramping the gas turbine 14 at a ramping rate for a certain time period that will cause one or more pressure fluctuations and/or a change of temperature rate that exceed the threshold pressure change and the threshold temperature change rate. However, the energy system 10 of the present disclosure can distinguish when such ramp rates are necessary and limit the number of times the gas turbine 14 is ramped at a ramp rate that will produce a temperature change rate that exceeds the threshold temperature change rate or creates pressure fluctuations greater than the threshold pressure change. A ramp rate that includes either producing pressure fluctuations greater than the threshold pressure change or producing a change of temperature rate greater than the threshold temperature rate is referred to herein as a “high ramp rate.”

By minimizing the number of times the gas turbine 14 ramps including the high ramp rate, the lifetime of the components of the gas turbine 14 can be extended and the efficiency of the gas turbine 14 can be increased. By increasing the lifetime of the components of the gas turbine 14, the expense for maintaining and running the gas turbine 14 can be reduced and the operating costs of the gas turbine 10 can be reduced.

The fuel valve 12 can adjust the flow rate of the fuel supplied to the gas turbine 14. For example, when the load of the gas turbine 14 is ramped up or ramped down, the fuel valve 12 can be adjusted to change the rate of fuel supplied to the gas turbine 14. Stated differently, to change the ramp rate of the gas turbine 14, the rate of fuel that is supplied to the gas turbine 14 can be changed via, for example, the fuel valve 12. For example, to increase the ramp rate, the rate of fuel supplied to the gas turbine 14 can be increased and to decrease the ramp rate of the gas turbine 14 the rate of fuel supplied to the gas turbine 14 can be decreased.

Throughout the disclosure, adjusting the ramp rate of the gas turbine 14 is discussed in terms of adjusting a position of a fuel valve 12. That is, to change the ramp rate of the gas turbine 14, a position of the fuel valve can change thereby increasing or decreasing the amount of fuel supplied to the gas turbine 14. Each position of the fuel valve 12 can correspond to a ramp rate. For example, the fuel valve 12 can include a closed position, a maximum position, a threshold position, and a plurality of intermediate positions. In an example, changing a position of the fuel valve 12 can change a size of an opening (e.g., aperture) that supplies the fuel to the gas turbine 14. In the closed position, the fuel valve 12 can be shut (e.g., the opening that supplies the fuel to the gas turbine 14 is closed) and no fuel is supplied to the gas turbine 14. In the maximum position, the fuel valve 12 is at a position that corresponds to a maximum ramping rate capability of the gas turbine 14. In one example, the maximum position of the fuel valve can correspond to the maximize size of the opening that supplies the fuel to the gas turbine 14. That is, physically the fuel valve 12 cannot be moved to any further position to increase the size of the opening that supplies fuel to the gas turbine 14. In another example, the maximum of the fuel valve 12 corresponds to the maximum ramping rate, but is not necessarily the physical limit of the fuel valve 12.

The maximum ramp rate capability of the gas turbine 14 is defined as megawatts per min that the gas turbine 14 can move based on the design envelope of the particular gas turbine 14 as well as preventing the gas turbine 14 from stalling. That is, gas turbines 14 may have the capability to operate at a particular ramp rate, however, that particular ramp rate may cause the gas turbine to stall. Thus, the maximum ramping rate is depending on stalling conditions as well as the gas turbines design envelope.

The threshold position can be a predetermined range less than the maximum ramping rate and correspond to a threshold ramping rate The threshold ramping rate can produce a pressure fluctuation equal to or greater than the threshold pressure change and/or produce a change of temperature rate equal to or greater than the threshold temperature change rate.

The plurality of intermediate positions of the fuel valve 12 can include positions between the closed position and the maximum position, where each intermediate position corresponds to an intermediate ramping rate. The intermediate ramp rate can be a ramp rate that is known not produce a temperature rate change that exceeds the threshold temperature change rate.

In an example, the fuel valve 12 can include a minimum movement capability. The minimum movement capability can be a change in the position of the fuel valve 12 that increases the flow rate of the fuel to the gas turbine 14 a predefined amount that does not cause detrimental pressures changes (e.g., fluctuations) within the gas turbine 14. As discussed herein, when the gas turbine 14 begins the ramping process (in response to receiving a command for a new load set-point), the initial change in the flow rate of fuel can cause a pressure fluctuations, which can be detrimental to the gas turbine 14 components, as discussed herein. The minimum movement capability of the fuel valve 12 can correspond to a minimum ramp rate. The minimum ramp rate can be a ramp rate that is known not to cause the fluctuations or pulsations outside of the threshold pressure change when the flow rate of the fuel to the gas turbine 14.

As discussed herein, when a new load set-point is received for the gas turbine, previous approaches have generally ramped the gas turbine 14 at a constant pre-determined ramp rate. Generally, the pre-determined ramp rate of the previous approaches is the maximum ramp rate of the gas turbine 14 to reach the new load set-point as fast as possible, while preventing the gas turbine 14 from stalling. However, ramping at the maximum ramp rate can produce temperature change rates and potential pressure fluctuations beyond the threshold temperature change rate and the threshold pressure change.

As discussed herein, adjusting the ramp rate of the gas turbine 14 is generally discussed in terms of adjusting a position of a fuel valve 12. However, adjusting the position of a fuel valve 12 can also include, for example, adjusting a fuel pump that can change the flow rate of fuel to the gas turbine 14. Therefore, adjusting or metering the fuel valve 12 is generally meant to include changing the flow rate of fuel supplied to the gas turbine. In an example, changing the flow rate of fuel to the gas turbine 14 can include, but is not limited to, a fuel valve 12 being adjusted to change the size of an opening that supplies the fuel to the gas turbine 14 or changing the flow rate of the fuel via a fuel pump 12.

The energy system 10 can include the controller 24 that can be used to control the operation of the gas turbine 14 including, but not limited to, ramping the gas turbine 14 when a new load set-point is received. The controller 24 can be electrically coupled to at least one of the fuel valve 12, the pressure sensor 20, and the temperature sensor 22. The controller 24 can include a memory 28, an interface 30, an alarm 32, a sensor signal circuit 34, and a ramp rate control unit 36. The controller 24 can form or be part of one or more computers. As illustrated in the example, the memory 28, the interface 30, the alarm 32, the sensor signal circuit 34, and the ramp rate control unit 36 are in communication with the processor 26. The processor 26 be configured to execute instructions to operate, including ramping, the gas turbine 14.

In an example, the signal sensor circuit 34 can receive a signal indicating a command for a new load set-point for the gas turbine 14. In an example, the command can be received from multiple sources. The signal indicating a command for a new load set-point can include a number of inputs or factors, including, but not limited to: coming from an operator, coming from a management system, or resulting from at least one of a gas turbine transient, energy facility transient, an environmental transient, a grid transient, and an economic transient.

In an example, the signal sensor circuit 34 can also receive signals from the fuel valve and the sensors 20, 22. The signals received from the sensors 20, 22 can include the operating temperature and operating pressure of the gas turbine 14. The signal received from the fuel valve 12 can include a current fuel valve position and/or current fuel flow rate.

As discussed herein, each ramp rate can cause an initial pressure fluctuation and temperature change rate within the gas turbine 14. Depending on the fuel used, the air-fuel ratio, and the efficiency of the gas turbine 14, the initial pressure fluctuation and temperature change rate can be different for each ramp rate including different fuels and/or air-fuel ratios. Further, the initial pressure fluctuation and temperature change rate for a particular ramp rate, can change overtime as the efficiency decreases or the fuel and/or air-fuel ratio changes. The memory 28 can provide storage for various combinations of ramp rates, fuels used, and air-fuel ratios. For example, overtime the memory 28 can be updated with the most current initial pressure fluctuations and temperature change rates, associated with various operating parameters including, but not limited to, the ramp rate, the fuel used, and the air-fuel ratio. As discussed herein, the memory 28 can be accessed by the ramp rate control unit 36 when determining various ramp rates for the gas turbine 14. The memory 28 can also be used to save the ramp profiles (including the ramp rates and pressure and temperature change profiles and pressure and temperature change rate profiles for various ramp sessions). These ramp profiles can be accessed later for use later by technicians.

The interface 30 can include a keyboard, a touchpad, a screen, a printer, a network interface, or other component configured to allow a user to view and monitor the ramp profiles. In one example, the ramp profiles can be plotted and displayed to a user via the interface 30. The alarm 32 can be signaled for various reasons. For example, if there is a pressure fluctuation and/or temperature change rate that is approaching or exceeding the threshold pressure change or the threshold temperature change rate, the alarm 32 can be signaled to alert a technician.

The ramp rate control unit 36 can be used to determine the ramp rates to be used during ramping of the gas turbine 14 when a new load set-point is received. For example, in response to receiving a new load set-point the ramp rate circuit 38 can send a signal to the fuel valve 12 to meter the fuel valve 12 of the gas turbine 14 to a first position. In an example, the first position can correspond to a first gas turbine load that is less than the new load set-point and a first ramp rate. After a period of time (e.g., once the first gas turbine load is reached), the ramp rate circuit 38 can meter the fuel valve 12 to a second position, the second position corresponding to the new load set-point for the gas turbine 14 and a second ramp rate. In an example, the second ramp rate is greater than the first ramp rate. In an example, the first ramp rate is the ramp rate associated with the minimum movement capability of the fuel valve 12, as discussed herein. In an example, prior to metering the fuel valve 12 to the second position, the ramp rate circuit 38 can meter the fuel valve 12 to one or more intermediate positions, each intermediate positions correspond to an intermediate gas turbine load that is greater than the first gas turbine load and less than the second gas turbine load.

The operating parameters circuit 44 can receive signals regarding the current pressure, current temperature, current temperature change rage, and current ramp rate, along with the type of fuel being used and the current air-fuel ration for use by the ramp rate circuit 38 in determining various ramp rates during ramping a gas turbine 14 to a new load set-point. The threshold circuit 40 can access the memory 28 to determine the threshold pressure change and the threshold temperature change rate for the current operating parameters. The load-set-point circuit 42 can receive the new load set-point and determine response time demand.

In an example, the new load set-point can be a result of a number of different market demands, each of which has a unique response time demand. For example, a new load set-point request in response to arrest a system transient has an immediate response time demand. A new load set-point in response to economic factors has a low priority response time demand. The load set-point circuit 42 can determine the response time demand associated with the new load set-point.

The energy system 10 of the present disclosure can provide ramping the gas turbine 14 to a new load set-point using at least two different ramp rates, where the first ramp rate is less than the second ramp rate. During the ramping, the load set-point circuit 42 can be used to determine how much more the gas turbine needs to be ramped to reach the new load set-point and adjust the ramp rates accordingly such that the new load set-point is reached within any received response time demand.

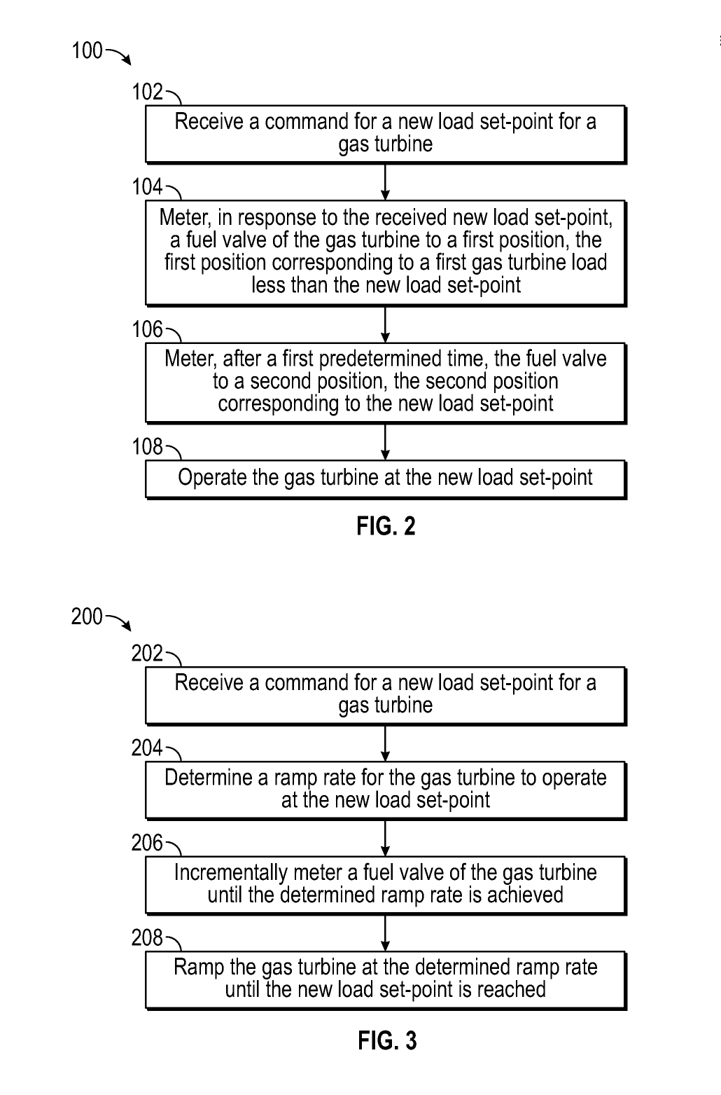

FIG. 2 illustrates a flow diagram of an example method 200 of operating a gas turbine, according to one example of the present disclosure. The method 200 is described in reference to the energy system 10 shown in FIG. 1. At 102, the method 200 can include receiving, at a controller, a command for a new load set point for a gas turbine, such as controller 24 receiving a new load set point for gas turbine 14.

A new load set-point can include a power output, such as in megawatts, of a gas turbine. In the present disclosure examples are directed generally toward a new load set-point that is greater than a current running state of the gas turbine, however the present disclosure is not so limited. For example, prior to receiving the new load set-point command, the gas turbine can be operating at a current load set-point, where the current load set-point is lower than the new set-point. As discussed herein, the new load set-point can be received from at least one of an operator or a management system, such as a gas turbine management system or an energy facility management system.

In an example, the new load set-point command is received from the operator or the gas turbine management system in response to a new load set-point event. The new load set-point event includes an event that fluctuates at least one of frequency, voltage, or power flow. A new load set-point event includes, but is not limited to, a gas turbine system transient, an energy facility transient, an environmental transient, and a grid system transient.

At 104, the method 100 can include, in response to the received new load set-point, metering the fuel valve of the gas turbine to a first position, where the first position corresponds to a first gas turbine load less than the new load set-point. For example, the ramp rate control unit 36 can determine the first position of the fuel valve 12 that corresponds to a first gas turbine load. The first gas turbine load is greater than the current load and less than the new load set-point. In an example, the first position can correspond to the minimum movement capability of the fuel valve, as discussed herein. Further, the first position can correspond to a ramp rate that does not cause a pressure fluctuation that exceeds the threshold pressure change.

At 106, the method 100 can include, after a predetermined time, meter the fuel valve to a second position, where the second position corresponds to the new load set-point. The first position of the fuel valve 12 can correspond to a first ramp rate and the second position of the fuel valve 12 can correspond to a second ramp rate, where the second ramp rate is greater than the first ramp rate. Having the first position of the fuel valve, which can be the minimum movement capability of the fuel valve, correspond to the first ramp rate can provide an initial ramp rate such that when the flow rate of fuel to the gas turbine 14 initially changes at the beginning of a ramp, the change in flow rate of fuel does not cause a spike or fluctuation in pressure that exceeds the threshold pressure.

In an example, the predetermined time can be determined based partially on a variety of factors including, but not limited to, the response time demand and the threshold temperature change rate. In an example, the threshold temperature change rate for various ramp rates are already known and stored in memory 28. The ramp rate circuit 38 can select one or more positions of the fuel valve 12 that correspond to one or more ramp rates and adjust the fuel valve 12 to the second position, such that the new load set-point can be reached within the response time demand, without having the temperature change rate exceed the threshold temperature change rate or cause pressure fluctuations that exceed the threshold pressure change.

In another example, after the first gas turbine load is reached, the ramp rate circuit 38, after the first predetermined time and prior to metering the fuel valve to the second position corresponding the new load set-point, the ramp rate control unit 36 can meter the fuel valve to one or more intermediate positions, where the one or more intermediate positions correspond to one or more gas turbine loads that are greater than the first gas turbine load and less than the new load set-point. For example, after the first gas turbine load is reached, the controller 24 can monitor at least the temperature change rate while continually increasing the ramp rate in increments until the temperature change rate is within a predefined range of the threshold temperature change rate. Thus, the gas turbine 14 can be ramped at one or more e ramp rates after the first gas turbine load is reached, which can be the fastest ramp rate the gas turbine 14 can operate at to achieve the new load set-point without exceeding or coming within a predefined range of the threshold temperature change rate and/or threshold pressure change.

In an example, the intermediate position corresponding to an intermediate ramp rate can be determined based on one or more of a variety of factors. For example, the intermediate position corresponding to the intermediate ramp rate can be determined based on at least the threshold temperature change rate. Further, the intermediate gas turbine load can be selected based on any response time demand and a difference from the first gas turbine load to the new load set-point. For example, the intermediate gas turbine load can be a percentage of the difference from the first gas turbine load.

The method 100 can also include incrementally metering the fuel valve after either the first gas turbine load and/or the intermediate gas turbine load is reached until the new load set-point is reached. For example, once the intermediate gas turbine load is reached, the fuel valve 12 can be incrementally moved to a new position (e.g., increased) until either the new load set-point is reached or the temperature rate of change comes within a range of or, in an example, exceed the threshold temperature change. In an example, incrementally metering the fuel valve can be at least partially based on at least one of a type of fuel combusted in the gas turbine and an air-fuel ratio combusted in the gas turbine.

At 108, the method 100 can include operating the gas turbine 14 at the new load set-point. The gas turbine 14 can be operated at the new load set-point until another new load set-point is received at the controller 24.

FIG. 3 illustrates a flow diagram of method 200 for ramping a gas turbine, according to one example of the present disclosure. The method 300 is described in reference to the energy system 10 shown in FIG. 1. At 202, the method 200 can include receiving, at a controller, a command for a new load set point for a gas turbine, as discussed herein.

At 204, the method 200 can include determining a ramp rate for the gas turbine to operate at the new load set-point. In an example, the determined ramp rate can be the time it takes the gas turbine 14, at the current load set-point, to achieve the new load set-point within a predetermined time (e.g., the response time demand). The determined ramp rate, in various examples, can be from about 2 seconds to about 20 minutes or more.

At 206, the method 200 includes incrementally metering a fuel valve of the gas turbine until the determined ramp rate is achieved. Incrementally metering the fuel valve can include a first incremental metering at a minimum ramp rate less than the determined ramp rate. In an example, the ramp rate circuit 38 can send a signal to change the position of the fuel valve 12, which increases/decreases the flow rate of fuel to the gas turbine 12 to change the ramp rate of the gas turbine 14. In an example, the first incremental metering can be a minimum movement capability of the fuel valve. The minimum movement capability can correspond to a minimum ramp rate. As discussed herein, the minimum ramp rate is a reduced ramp rate that does not produce a pressure fluctuation and/or temperature change rate that exceeds the threshold pressure change or the threshold temperature change rate.

At 208, the method 200 can include ramping the gas turbine at the determined ramp rate until the new load set-point is reached. In an example, prior to ramping the gas turbine 14 as the determined ramp rate, the fuel valve 12 can be incrementally metered such that the gas turbine operates at one or more intermediate ramp rates less that are greater than the minimum ramp rate

In an example, incrementally metering the fuel valve can at least partially based on a type of fuel combusted in the gas turbine. In an example, incrementally metering the fuel valve includes doubling an aperture of the fuel valve each subsequent incremental metering to the first metering.

In an example, incrementally metering the fuel valve 12 can include incrementally increasing the ramp rate of the gas turbine including a plurality of ramp rates. In an example, incrementally metering the fuel valve can include substantially maintaining the gas turbine 14 at or below at least the threshold temperature threshold. For example, the threshold circuit 40 can continuously monitor the pressure change and temperature change rate to make sure that each new ramp rate does not produce a pressure change (e.g., fluctuation) or temperature change rate that exceeds the threshold pressure change or threshold temperature change rate.

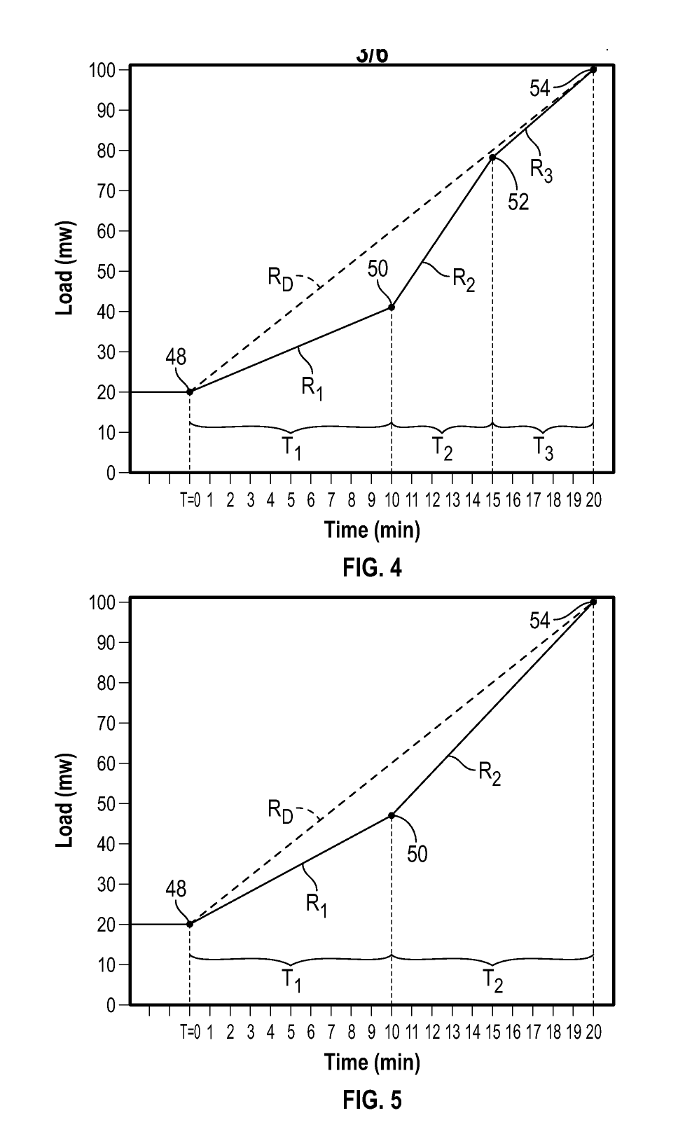

FIGS. 4-11 illustrate plots of an example ramp profile. The values represented in FIGS. 4-11 are merely for example and are not limiting. The plots in FIGS. 4-11 the load, in megawatts (MW), on the y-axis, and time, in minutes (min), on the x-axis. As shown, the gas turbine, prior to a time of zero minutes, is running at the current load set-point 48. At t=0 the new load set-point command is received, as described herein. The new set-point command can include the new load set-point 54. In FIGS. 4-11, the response time demand is 15 or 20 minutes, the current load set-point 48 is 20 MW, and the new load set-point is 100 M. However, it should be understood that these values are being used for simplicity and are in no way limiting. A determined ramp rate R_{D} is shown as a dashed line and illustrates a constant ramp rate to reach the new load set-point 54.

In FIG. 4, the ramp profile includes three ramp rates, R1, R2, and R3. The response time demand is 20 minutes and equals T1+T2+T3, which is the amount of time spent at each ramp rate. In an example, in response to receiving a new load set-point command, the fuel valve can be metered to a first position corresponding to a first gas turbine load 50, less than the new load set-point and greater than the current load set-point 48, and a first ramp rate R1.

In an example, R1 can be the minimum ramp rate and is less than the determined ramp rate R_{d}. In FIG. 3, time T1 is 10 minutes, however, the time spent at the first ramp rate R1 can vary. In an example T1 can be less than T2

After time T1, the fuel valve can be metered to a second position corresponding to a second ramp rate R2 and a second gas turbine load 52, which is greater than the first gas turbine load 50 and less than the new load set-point 52. The gas turbine can be ramped at ramp rate R2, which is greater than ramp rate R1, for a time T2. In FIG. 4, time T2 is 5 minutes, however, other times can be spent at the second ramp rate. After the second gas turbine load 52 is reached, the fuel valve can be incrementally metered until the new load set-point is reached. While between the second gas turbine ramp rate 52 and the new load set-point 54 can include a plurality of different ramp rates, greater than or less than the second ramp rate, the example shown in FIG. 4 includes a third ramp rate R3 that is less than the second ramp rate R2 and greater than the first ramp rate R1.

In FIG. 5, the ramp profile includes two ramp rates, R1 and R2. The response time demand is 20 minutes and equals T1+T2, which is the amount of time spent at each ramp rate. The first ramp rate R1 can be the minimum ramp rate, which is less than the determined ramp rate Rd and the second ramp rate R2. As seen in the example of FIG. 5, after the first gas turbine load 50, the second ramp rate is used to reach the new load set-point 54. The time T1 at the first ramp rate T1 equals the time T2 at the second ramp rate T2, however, the examples are no so limited. For example, T1 can be less than or greater than T2.

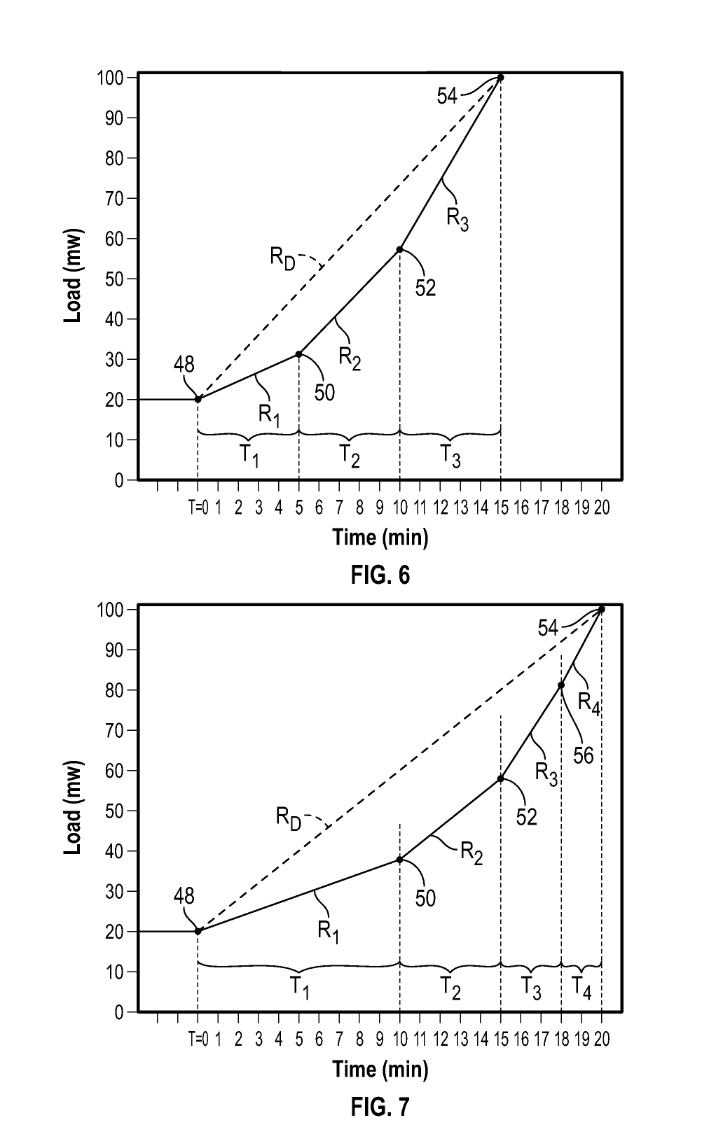

In FIG. 6, the ramp profile includes three ramp rates, R1, R2, and R3. The response time demand is 15 minutes and equals T1+T2+T3, which is the amount of time spent at each ramp rate. The first ramp rate R1 can be the minimum ramp rate, which is less than the determined ramp rate Rd, the second ramp rate R2, and the third ramp rate R3. The second ramp rate R2 is greater than R1 and less than R3 and the third ramp rate R3 is greater than R1 and R2. In FIG. 6, times T1, T2, and T3 equal each other.

In FIG. 7, the ramp profile includes four ramp rates R1, R2, R3, and R4. The response time demand is 20 minutes and equals T1+T2+T3+T4, which is the amount of time spent at each ramp rate. The first ramp rate R1 can be the minimum ramp rate, which is less than the determined ramp rate Rd, the second ramp rate R2, the third ramp rate R3, and the fourth ramp rate R4. The second ramp rate R2 is greater than R1 and less than R3 and the third ramp rate R3 is greater than R1 and R2. FIG. 7 illustrates incrementally metering a fuel valve of the gas turbine until the new load set-point is achieved, including at least a first incremental metering at a minimum ramp rate (e.g., ramp rate R1) less than the determined ramp rate (Rd).

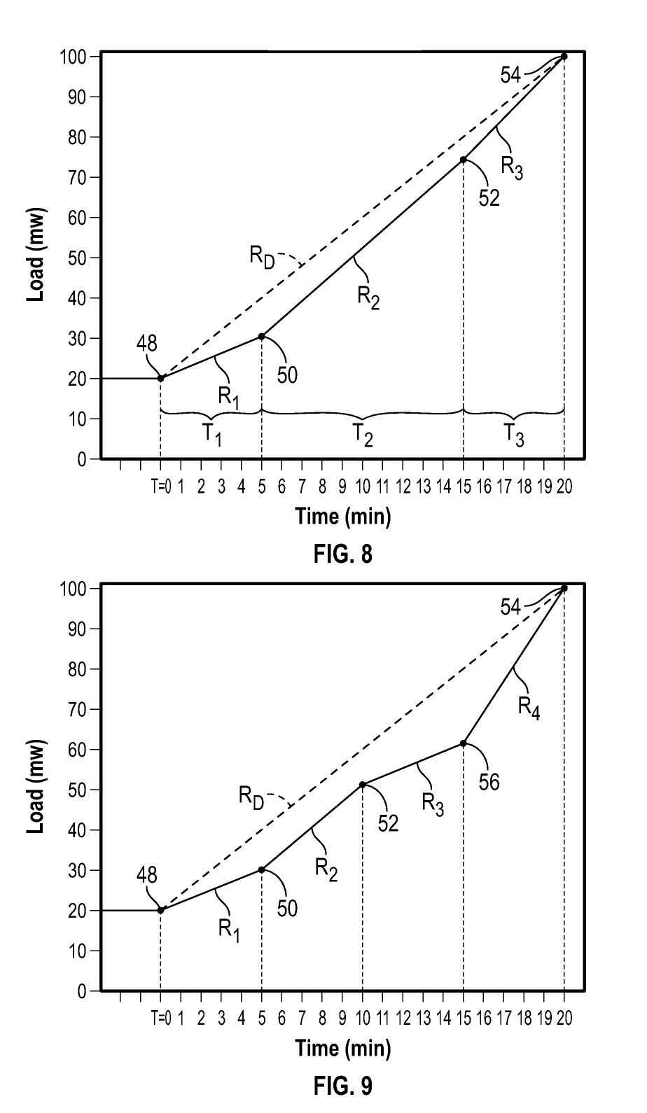

In FIG. 8, the ramp profile includes three ramp rates R1, R2, and R3. The response time demand is 20 minutes and equals T1+T2+T3, which is the amount of time spent at each ramp rate. The first ramp rate R1 can be the minimum ramp rate, which is less than the determined ramp rate Rd, the second ramp rate R2, and the third ramp rate R3. However, in FIG. 8, the second ramp rate R2 can equal the determined rate Rd (that is the change in MW/time is the same). The third ramp rate R3 is greater than the first ramp rate R1 and the second ramp rate R2. However, in an example, the third ramp rate R3 could be less than the ramp rate R2. Additionally, from the second gas turbine load 52 to the new load set-point 54, the profile could include a plurality of different ramp rates. The second ramp rate R2 is greater than R1 and less than R3 and the third ramp rate R3 is greater than R1 and R2. FIG. 7 illustrates incrementally metering a fuel valve of the gas turbine until the new load set-point is achieved, including at least a first incremental metering at a minimum ramp rate (e.g., ramp rate R1) less than the determined ramp rate (Rd). In the example shown in FIG. 8, at least one second incremental metering at the predetermined ramp rate.

In FIG. 9, the ramp profile includes four ramp rates R1, R2, R3, and R4. The response time demand is 20 minutes and equals T1+T2+T3+T4, which is the amount of time spent at each ramp rate. The first ramp rate R1 can be the minimum ramp rate, which is less than the determined ramp rate Rd, the second ramp rate R1, the third ramp rate R3, and the fourth ramp rate R4. One or more of ramp rates R1, R2, R3, and R4 can equal Rd, be less than Rd or be greater than Rd.

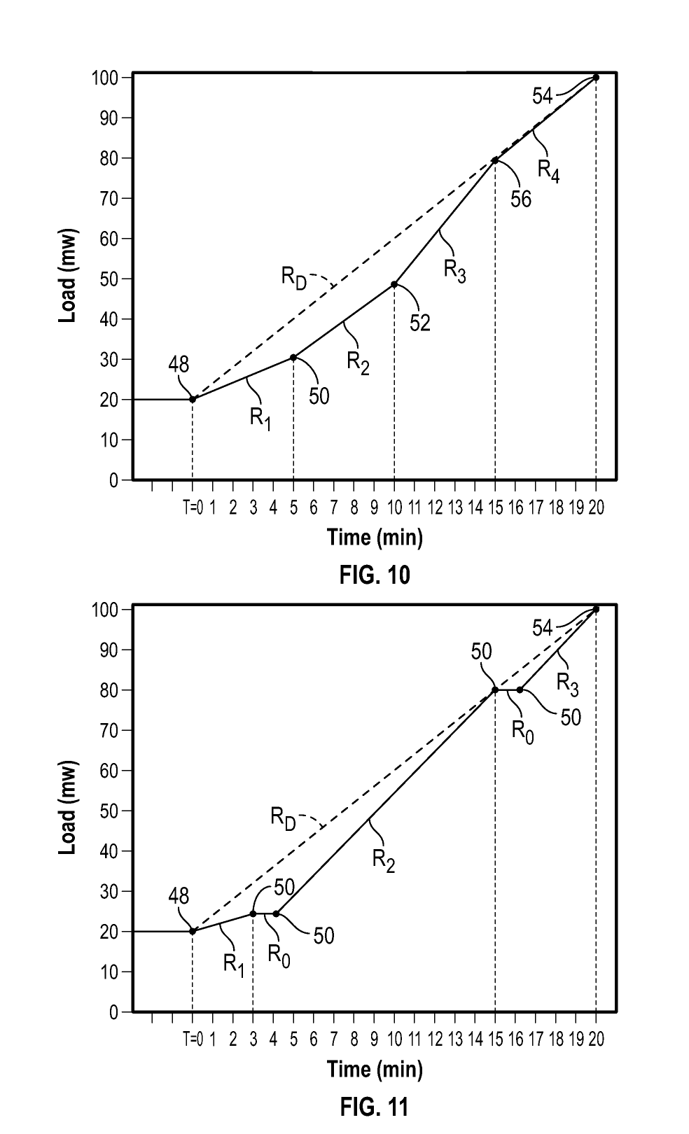

In FIG. 10, the ramp profile includes four ramp rates R1, R2, R3, and R4. The response time demand is 20 minutes and equals T1+T2+T3+T4, which is the amount of time spent at each ramp rate. The first ramp rate R1 can be the minimum ramp rate, which is less than the determined ramp rate Rd, the second ramp rate R2, the third ramp rate R3, and the fourth ramp rate R4. The last ramp rate R4 that is used to reach the new load set-point 54 can substantially equal the determined ramp rate Rd. As shown in FIG. 10, two intermediate ramp rates R2 and R3 are used between the minimum ramp rate R1 and the determined ramp rate R4. The intermediate ramp rates R2 and R3 can be greater than or less than the determined ramp rate Rd.

In FIG. 11, the ramp profile includes three ramp rates R1, R2, and R3. The response time demand is 20 minutes and equals T1+T2+T3, which is the amount of time spent at each ramp rate. The first ramp rate R1 can be the minimum ramp rate, which is less than the determined ramp rate Rd, the second ramp rate R1, the third ramp rate R2. As seen in FIG. 11, the second ramp rate R2 can be greater than the first ramp rate R1, the third ramp rate R3, and the determined ramp rate Rd.

As seen in an example, before ramping to a new load point, for example, from the first gas turbine load 50 to the second gas turbine load 50 and from the second gas turbine load 50 to the new load set-point 54, the ramp rate can go to zero such as at Ro shown between the first ramp rate R1 and the second ramp rate R and between the second ramp rate R2 and the third ramp rate R3.

The various plots illustrated in FIGS. 4-11 illustrate various ramping profiles that can be determined by the ramp rate control unit 36. The plots include at least a first ramp rate that is a minimum ramp rate, which is one that will not cause a pressure spike or fluctuation exceeding the threshold pressure change when the flow rate of fuel changes to initiate a ramp. Further, a subsequent ramp rate can be greater than the first ramp rate but is determined based on at least the threshold temperature change rate. The methods and systems of the present disclosure can minimize the number of times the pressure fluctuations beyond the threshold pressure change or the temperature change rate exceeds the threshold temperature change rate, which can increase the efficiency of the gas turbine and the life of the gas turbine and components of the gas turbine.

### Additional Notes

In the event of inconsistent usages between this document and any documents so incorporated by reference, the usage in this document controls. In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

The term “substantially simultaneously” or “substantially immediately” or “substantially instantaneously” refers to events occurring at approximately the same time. It is contemplated by the inventor that response times can be limited by mechanical, electrical, or chemical processes and systems. Substantially simultaneously, substantially immediately, or substantially instantaneously can include time periods 1 minute or less, 45 seconds or less, 30 seconds or less, 20 seconds or less, 15 seconds or less, 10 seconds or less, 5 seconds or less, 3 seconds or less, 2 seconds or less, 1 second or less, 0.5 seconds or less, or 0.1 seconds or less.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 20 MW to about 25 MW” should be interpreted to include not just about 20 MW to about 25 MW but also the individual values (e.g., 21 MW, 22 MW, 23 MW, and 24 MW and the sub-ranges (e.g., 21.1 MW, 21.2 MW, 21.3 MW, and the like) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about” as used herein can allow for a degree of variability in a value or range, for example, within 10%, within 5%, or within 1% of a stated value or of a stated limit of a range.

In the methods described herein, the steps can be carried out in any order without departing from the principles of the inventive subject matter, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method for operating a gas turbine, comprising:
receiving, at a controller, a command for a new load set-point for a gas turbine;
in response to the received new load set-point, metering a fuel valve of the gas turbine to a first position, the first position corresponding to a first gas turbine load less than the new load set-point;
after a first predetermined time, metering the fuel valve to a second position, the second position corresponding to the new load set-point; and
operating the gas turbine at the new load set-point.

2. The method of claim 1, wherein the first position corresponds to a first ramp rate and the second position corresponds to a second ramp rate, the second ramp rate greater than the first ramp rate.

3. The method of claim 1, wherein the first position corresponds to a minimum movement capability of the fuel valve.

4. The method of claim 1, further including determining the first predetermined time at least partially based on a threshold pressure change rate.

5. The method of claim 1, further including determining the first predetermined time at least partially based on a threshold temperature change rate.

6. The method of claim 1, further including determining the first predetermined time based on at least partially on an energy product associated with the command for the new load set-point.

7. The method of claim 1, further including, after the first predetermined time and prior to metering the fuel valve to the second position, metering the fuel valve to an intermediate position, the intermediate position corresponding to a second gas turbine load less than the new load set-point and greater than the first load set-point.

8. The method of claim 7, wherein the intermediate position is at least partially based on one of a threshold pressure change rate and a threshold temperature change rate.

9. The method of claim 7, further including, after the second gas turbine load is reached, metering the fuel valve to the second position.

10. A method for ramping a gas turbine, comprising:
receiving, at a controller, a command for a new load set-point for a gas turbine;
determining a ramp rate for the gas turbine to operate at the new load set-point;
incrementally metering a fuel valve of the gas turbine until the determined ramp rate is achieved; and
ramping the gas turbine at the determined ramp rate until the new load set-point is reached.

11. The method of claim 10, wherein incrementally metering the fuel valve includes a first incremental metering at a ramp rate less than the determined ramp rate.

12. The method of claim 10, wherein the first incremental metering is a minimum movement capability of the fuel valve.

13. The method of claim 12, wherein incrementally metering the fuel valve includes doubling an aperture of the fuel valve each subsequent incremental metering to the first metering.

14. The method of claim 10, wherein incrementally metering the fuel valve includes incrementally increasing the ramp rate of the gas turbine.

15. The method of claim 10, wherein incrementally metering the fuel valve includes substantially maintaining the gas turbine at or below at least one of a threshold pressure and threshold pressure change rate.

16. The method of claim 10, wherein incrementally metering the fuel valve includes substantially maintaining the gas turbine at or below a threshold temperature.

17. The method of claim 10, wherein incrementally metering the fuel valve includes substantially maintaining the gas turbine at or below a threshold temperature change rate.

18. The method of claim 10, wherein incrementally metering the fuel valve includes a first incremental metering at a minimum ramp rate based at least partially on the response time demand associated with the new load set-point.

19. A system for controlling a gas turbine, comprising:
a gas turbine engine;
a fuel valve configured to supply fuel to the gas turbine;
a temperature sensor configured to sense a temperature within the gas turbine;
a pressure sensor configured to sense a pressure within the gas turbine; and
a controller electrically coupled to the fuel valve, the temperature sensor, and the pressure sensor, the controller configured to receive a command including a new load set-point for the gas turbine, the controller, including:
a ramp rate control unit configured to:
in response to receiving the new load set-point, metering the fuel valve of the gas turbine to a first position, the first position corresponding to a first gas turbine load less than the new load set-point and a first ramp rate; and
metering the fuel valve to a second position, the second position corresponding to the new load set-point for the gas turbine and a second ramp rate, the second ramp rate greater than the first ramp rate.

20. The system of claim 1, further including prior to metering the fuel valve to the second position, metering the fuel valve to one or more intermediate positions, each intermediate position correspond to an intermediate gas turbine load greater than the first gas turbine load and less than the second gas turbine load.
